(19) United States
(12) Patent Application Publication
(10) Pub. No.: US 2023/0289567 A1
(43) Pub. Date: Sep. 14, 2023

(54) Data Processing Method, System and Device, and Readable Storage Medium

(71) Applicant: INSPUR SUZHOU INTELLIGENT TECHNOLOGY CO., LTD., Jiangsu (CN)

(72) Inventors: Lingyan LIANG, Jiangsu (CN); Gang DONG, Jiangsu (CN); Yaqian ZHAO, Jiangsu (CN)

(21) Appl. No.: 18/013,793

(22) PCT Filed: Feb. 25, 2021
(86) PCT No.: PCT/CN2021/077801

§ 371 Date: Dec. 29, 2022

(30) Foreign Application Priority Data
Jul. 29, 2020 (CN) 202010745395.3

(51) Int. Cl. G06N 3/0464; G06N 3/091

(52) U.S. Cl. CPC G06N 3/0464; G06N 3/091

(57) ABSTRACT

A data processing method, system and device, and a readable storage medium. The method includes: marking each layer of a network model as a key layer or a non-key layer according to acquired structural information of the network model; respectively determining a quantization bit width range of the key layer and a quantization bit width range of the non-key layer according to hardware resource information that needs to be deployed; determining, in the quantization bit width range, optimal quantization bit widths of each layer of the network model; and training the network model based on the optimal quantization bit widths of each layer of the network model, so as to obtain an optimal network model, and performing data processing using the optimal network model. According to the present disclosure, for an optimal network model obtained by means of performing training based on an optimal quantization bit width, insofar as the optimal accuracy of the network model is ensured, the model structure is compressed to the maximum extent, so as to realize the optimal deployment of a hardware end, such that the efficiency of processing data by means of the optimal network model is improved.

The present disclosure claims priority to Chinese Patent Application No. 202010745395.3, filed to the China National Intellectual Property Administration on Jul. 29, 2020 and entitled “Data Processing Method, System and Device, and Readable Storage Medium”, which is incorporated herein by reference in its entirety.

### TECHNICAL FIELD

The present disclosure relates to the technical field of data processing, and in particular to a data processing method, system and device, and a readable storage medium.

### BACKGROUND

With the continuous development of artificial intelligence technology, the artificial intelligence technology has been gradually applied in daily life. In the field of artificial intelligence technology, deep learning is one of more typical techniques. Although the ability of a deep neural network in image classification, detection and other aspects has approached or surpassed human beings, there are still some problems in practical deployment, such as large model, high computational complexity, and relatively high requirements for hardware cost. However, in practical application, in order to reduce the hardware cost, a lot of neural networks are deployed on some terminal devices or edge devices, and these devices generally only have relatively low computing power and limited memory and power consumption.

Therefore, in order to truly deploy a deep neural network model, in a case of ensuring the accuracy of the network model to be unchanged, it is very necessary to make the network model smaller, so as to make reasoning faster and power consumption lower. There are two main research directions on this topic, one is to reconstruct an efficient lightweight model, and the other is to reduce the model size by quantization, cropping and compression. The current model quantification technology mainly includes two directions: post-training quantization without retraining and training-aware quantization. Regardless of the quantization model, researchers mostly preset a quantization bit width based on prior knowledge and then perform quantization processing, and less consider the actual network model structure and the hardware environment that needs to be deployed. As a result, the preset quantization bit width may not be suitable for the quantization of the network model structure, and may not be optimally deployed in the corresponding hardware environment, resulting in low efficiency when processing data using the network model.

Therefore, how to improve the efficiency of data processing is a technical problem to be solved by those skilled in the art at present.

### SUMMARY

An purpose of the present disclosure is to provide a data processing method, system and device, and a readable storage medium, which may be configured to improve the efficiency of data processing.

In order to solve the above technical problem, the present disclosure provides a data processing method, the method includes:
marking each layer of a network model as a key layer or a non-key layer according to acquired structural information of the network model;
respectively determining a quantization bit width range of the key layer and a quantization bit width range of the non-key layer according to hardware resource information that needs to be deployed;
determining, in the quantization bit width range, optimal quantization bit widths of each layer of the network model;
training the network model based on the optimal quantization bit widths of each layer of the network model, so as to obtain an optimal network model, and performing data processing using the optimal network model.

In an embodiment, the marking each layer of a network model as a key layer or a non-key layer according to acquired structural information of the network mode includes:
determining an initial network model parameter according to the acquired structural information of the network model, and sorting each layer of the network model;
marking a first layer of the network model as the key layer, and calculating a similarity between feature map of a current layer and feature map of a previous layer of the current layer in the network model according to the initial network model parameter;
marking the current layer as the key layer under the condition that the similarity is less than a threshold value; and
marking the current layer as the non-key layer under the condition that the similarity is greater than or equal to the threshold value.

In an embodiment, the determining, in the quantization bit width range, optimal quantization bit widths of each layer of the network model includes:
determining the number of training branches of a current layer of the network model according to the number of quantization bit widths in the quantization bit width range;
setting different first quantization bit widths for weights in different training branches of the current layer of the network model, and setting different second quantization bit widths for feature inputs in different training branches of the current layer of the network model;
mapping the weight to a weight value according to the first quantization bit width, and mapping the feature input to a feature input value according to the second quantization bit width.
performing convolution calculation on the weight value and the feature input value of each of the training branches, and updating an importance evaluation parameter of the training branch according to an obtained convolution operation result; and
determining the first quantization bit width and the second quantization bit width of the training branch with highest importance evaluation parameter as the optimal quantization bit widths of the current layer of the network model.

In an embodiment, any quantization bit wide in the quantization bit wide range of the key layer is greater than any quantization bit wide in the quantization bit wide range of the non-key layer.

In an embodiment, the network model may include at least one of an image classification model, an image detection model, an image recognition model, and a natural language processing model.

The present disclosure further provides a data processing system, the system includes:
a marking module, configured to mark each layer of a network model as a key layer or a non-key layer according to acquired structural information of the network model;
a first determination module, configured to respectively determine a quantization bit width range of the key layer and a quantization bit width range of the non-key layer according to hardware resource information that needs to be deployed;
a second determination module, configured to determine, in the quantization bit width range, optimal quantization bit widths of each layer of the network model;
a data processing module, configured to train the network model based on the optimal quantization bit widths of each layer of the network model, so as to obtain an optimal network model, and perform data processing by using the optimal network model.

In an embodiment, the marking module includes:
a sorting sub-module, configured to determine an initial network model parameter according to the acquired structural information of the network model, and sort each layer of the network model;
a first marking sub-module, configured to mark a first layer of the network model as the key layer, and calculate a similarity between feature map of a current layer and feature map of a previous layer of the current layer in the network model according to the initial network model parameter;
a second marking sub-module, configured to mark the current layer as the key layer under the condition that the similarity is less than a threshold value; and
a third marking sub-module, configured to mark the current layer as the non-key layer under the condition that the similarity is greater than or equal to the threshold value.

In an embodiment, the second determination module includes:
a first determination sub-module, configured to determine the number of training branches of a current layer of the network model according to the number of quantization bit widths in the quantization bit width range;
a setting sub-module, configured to set different first quantization bit widths for weights in different training branches of the current layer of the network model, and set different second quantization bit widths for feature inputs in different training branches of the current layer of the network model;
a mapping sub-module, configured to map the weight to a weight value according to the first quantization bit width, and map the feature input to a feature input value according to the second quantization bit width;
a update sub-module, configured to perform convolution calculation on the weight value and the feature input value of each of the training branches, and update an importance evaluation parameter of the training branch according to an obtained convolution operation result; and
a second determination sub-module, configured to determine the first quantization bit width and the second quantization bit width of the training branch with highest importance evaluation parameter as the optimal quantization bit widths of the current layer of the network model.

The present disclosure further provides a data processing device, the device includes: a memory, configured to store a computer program;
at least one processor, configured to implement operations of the above data processing method when executing the computer program.

The present disclosure further provides a computer-readable storage medium, wherein a computer program is stored on the computer-readable storage medium, and when the computer program is executed by at least one processor, the compute program implements operations of any one of the above data processing methods.

The data processing method provided by the present disclosure includes that: marking each layer of a network model as a key layer or a non-key layer according to acquired structural information of the network model; respectively determining a quantization bit width range of the key layer and a quantization bit width range of the non-key layer according to hardware resource information that needs to be deployed; determining, in the quantization bit width range, optimal quantization bit widths of each layer of the network model; and training the network model based on the optimal quantization bit widths of each layer of the network model, so as to obtain an optimal network model, and performing data processing using the optimal network model.

According to the technical solution provided by the present disclosure, by marking each layer of the network model as the key layer or the non-key layer according to the structural information, then respectively determining the quantization bit width ranges of the key layer and the non-key layer according to the hardware resource information, and then determining, in the quantization bit width range, optimal quantization bit widths of each layer of the network model, for the optimal network model obtained by means of performing training based on the optimal quantization bit width, insofar as the optimal accuracy of the network model is ensured, the model structure is compressed to the maximum extent, so as to realize the optimal deployment of a hardware end, such that the efficiency of processing data by means of the optimal network model is improved. The present disclosure further provides a data processing system and device, and a readable storage medium, which have the above beneficial effects and will not be elaborated herein.

### BRIEF DESCRIPTION OF THE DRAWINGS

In order to more clearly illustrate the embodiments of the present disclosure or the technical solutions in the related art, the drawings used in the description of the embodiments or the related art will be briefly described below. It is apparent that the drawings described below are only some embodiments of the present disclosure. Other drawings may further be obtained by those of ordinary skill in the art according to these drawings without creative efforts.

FIG. 1 is a schematic flowchart of a data processing method provided by an embodiment of the present disclosure.

FIG. 2 is a schematic flowchart of an actual expression of S101 in a data processing method provided by FIG. 1.

FIG. 3 is a schematic flowchart of an actual expression of S103 in a data processing method provided by FIG. 1.

FIG. 4 is a schematic diagram of determining an optimal quantization bit width provided by an embodiment of the present disclosure.

FIG. 5 is a structural diagram of a data processing system provided by an embodiment of the present disclosure.

FIG. 6 is a structural diagram of a data processing device provided by an embodiment of the present disclosure.

### DETAILED DESCRIPTION OF THE EMBODIMENTS

The core of the present disclosure is to provide a data processing method, system and device, and a readable storage medium, which may be configured to improve the efficiency of data processing.

In order to make the purposes, technical solutions and advantages of the embodiments of the present disclosure clearer, the technical solutions in the embodiments of the present disclosure will be clearly and completely described below in combination with the drawings in the embodiments of the present disclosure. It is apparent that the described embodiments are not all embodiments but only part of embodiments of the present disclosure. All other embodiments obtained by those of ordinary skill in the art on the basis of the embodiments in the present disclosure without creative work shall fall within the scope of protection of the present disclosure.

In the related art, researchers preset a quantization bit width based on prior knowledge and then perform quantization processing, and less consider the actual network model structure and the hardware environment that needs to be deployed. As a result, the preset quantization bit width may not be suitable for the quantization of the network model structure, and may not be optimally deployed in the corresponding hardware environment, resulting in low efficiency when processing data using the network model. Therefore, the present disclosure provides a data processing method for solving the above problems.

Referring to FIG. 1, FIG. 1 is a schematic flowchart of a data processing method provided by an embodiment of the present disclosure.

The method includes the following steps.

S101: marking each layer of a network model as a key layer or a non-key layer according to acquired structural information of the network model.

In the related art, a global search model is used in the quantization bit width search stage of the network model, which leads to more computing resources and time resources required to cause a waste of resources, and at the same time, leads to low efficiency of the quantization bit width search of the network model. Therefore, this step creatively marks each layer of the network model as the key layer or the non-key layer according to the structural information of the network model, and since the quantization bit width range of the key layer and the quantization bit width range the non-key layer are different, the key layer will perform quantization using a high quantization bit width, and the non-key layer will perform quantization using a low quantization bit width. Therefore, differential processing may be performed according to the category of each layer of the network model, which reduces the waste of resources on the basis of ensuring the accuracy of the model, and improves the efficiency of the quantization bit width search of the network model.

In an embodiment, the operation of marking each layer of the network model as the key layer or the non-key layer according to the acquired structural information of the network mode in S101 may be implemented by a method such as key layer selection based on Principal Component Analysis (PCA) or key layer selection based on Hessian matrix decomposition.

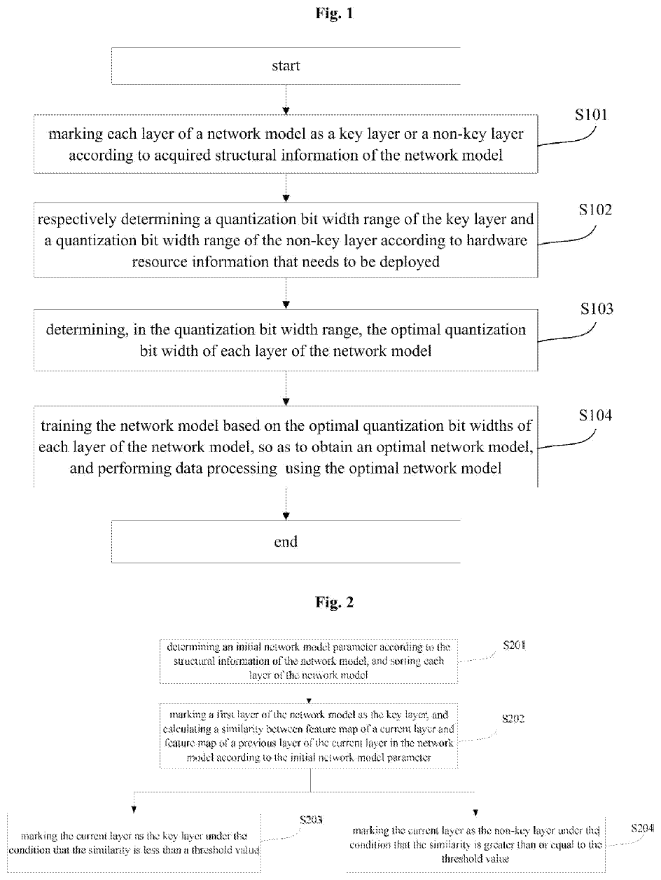

In an embodiment, the content described in S101 may also be implemented by executing the steps shown in FIG. 2, and referring to FIG. 2, FIG. 2 is a schematic flowchart of an actual expression of S101 in a data processing method provided by FIG. 1, which includes the following steps:

S201: determining an initial network model parameter according to the structural information of the network model, and sorting each layer of the network model;

S202: marking a first layer of the network model as the key layer, and calculating a similarity between feature map of a current layer and feature map of a previous layer of the current layer in the network model according to the initial network model parameter;

S203: marking the current layer as the key layer under the condition that the similarity is less than a threshold value; and

S204: marking the current layer as the non-key layer under the condition that the similarity is greater than or equal to the threshold value.

Based on the above technical solution, in the embodiments of the present disclosure, the similarity between the feature map of the current layer and the feature map of the previous layer in the network model is calculated according to the initial network model parameter, under the condition that the similarity between two adjacent layers is higher than the threshold value, it indicates that there may be information redundancy between the two adjacent layers, the layer is marked as the non-key layer, and quantization is performed using the low quantization bit width, so as to reduce the waste of resources; and conversely, under the condition that the similarity between two adjacent layers is lower than the threshold value, it indicates that the layer has different feature information from the previous layer, so that the layer is marked as the key layer, and quantization is performed using the high quantization bit width, so as to ensure that more detailed feature quantities are retained.

In an embodiment, the network model mentioned herein may include at least one of an image classification model, an image detection model, an image recognition model, and a natural language processing model. The embodiment of the present disclosure may select a corresponding network model for a service that needs to be performed for data processing.

S102: respectively determining a quantization bit width range of the key layer and a quantization bit width range of the non-key layer according to hardware resource information that needs to be deployed.

In this step, according to the hardware resource information, the maximum number of quantization bit widths currently bearable by the network model is estimated, and then different quantization bit width ranges are set for the key layer and the non-key layer. For example, if the maximum quantization bit width bearable by the hardware resources that need to be deployed is 8 bits, the quantization bit width range of the key layer may be set to [5 bit, Gbit, 7 bit, 8 bit], and the quantization bit width range of the non-key layer may be set to [1 bit, 2 bit, 3 bit, 4 bit].

In an embodiment, any quantization bit wide in the quantization bit wide range of the key layer is greater than any quantization bit wide in the quantization bit wide range of the non-key layer.

In an embodiment, the hardware resource information mentioned herein may include information such as the maximum model size or maximum computing resources bearable by the deployed platform.

S103: determining, in the quantization bit width range, the optimal quantization bit width of each layer of the network model.

After determining the quantization bit width range of each layer of the network model, the optimal quantization bit width of each layer of the network model is determined in the quantization bit width range, so that for the optimal network model obtained by performing training based on the optimal quantization bit width, insofar as the optimal accuracy of the network model is ensured, the model structure is compressed to the maximum extent, so as to realize the optimal deployment of a hardware end, such that the efficiency of processing data using the optimal network model is improved.

In an embodiment, the operation mentioned herein of determining, in the quantization bit width range, optimal quantization bit widths of each layer of the network model may determine the optimal quantization bit widths of each layer of the network model by a global search method or an exhaustive method.

S104: training the network model based on the optimal quantization bit widths of each layer of the network model, so as to obtain an optimal network model, and performing data processing using the optimal network model.

In an embodiment, after data processing is performed using the optimal network model, a prompt message for completion of data processing may also be output to remind the user to further process the processed data.

Based on the above technical solution, in the data processing method provided by the present disclosure, by marking each layer of the network model as the key layer or the non-key layer according to the structural information, then respectively determining the quantization bit width ranges of the key layer and the non-key layer according to the hardware resource information, and then determining, in the quantization bit width range, the optimal quantization bit widths of each layer of the network model, for the optimal network model obtained by performing training based on the optimal quantization bit widths, insofar as the optimal accuracy of the network model is ensured, the model structure is compressed to the maximum extent, so as to realize the optimal deployment of a hardware end, such that the efficiency of processing data using the optimal network model is improved.

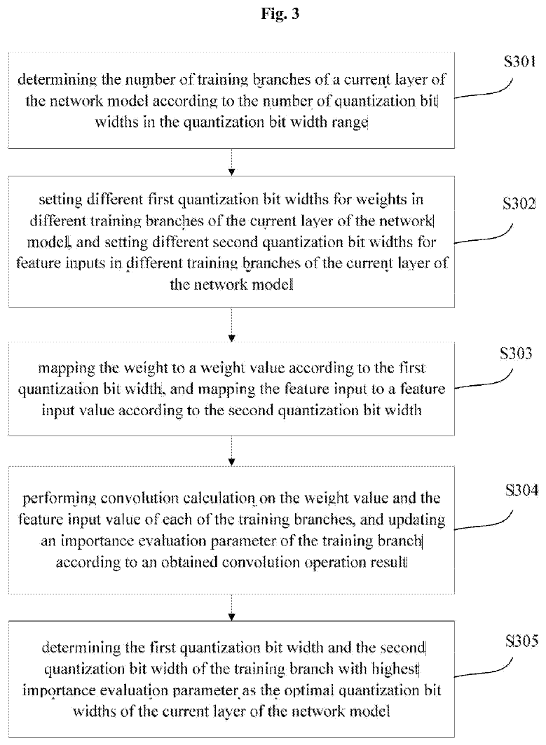

With respect to step S103 of the previous embodiment, the described operation of determining, in the quantization bit width range, optimal quantization bit widths of each layer of the network model may also be implemented by performing the steps shown in FIG. 3, which will be described below in combination with FIG. 3.

Referring to FIG. 3, FIG. 3 is a schematic flowchart of an actual expression of S103 in a data processing method provided by FIG. 1.

The method includes the following steps.

S301, determining the number of training branches of a current layer of the network model according to the number of quantization bit widths in the quantization bit width range.

For example, when the current layer is the key layer, the quantization bit width range thereof is [5 bit, 6 bit, 7 bit, 8 bit], the number of quantization bit widths is 4, the number of training branches of the current layer is 4×4=16, that is, quantization bit widths of weight includes four cases, quantization bit widths of feature input also includes four cases, and the number of training branches obtained by combining the two is 16.

S302: setting different first quantization bit widths for weights in different training branches of the current layer of the network model, and setting different second quantization bit widths for feature inputs in different training branches of the current layer of the network model;

S303: mapping the weight to a weight value according to the first quantization bit width, and mapping the feature input to a feature input value according to the second quantization bit width;

S304: performing convolution calculation on the weight value and the feature input value of each of the training branches, and updating an importance evaluation parameter of the training branch according to an obtained convolution operation result;

S305: determining the first quantization bit width and the second quantization bit width of the training branch with highest importance evaluation parameter as the optimal quantization bit widths of the current layer of the network model.

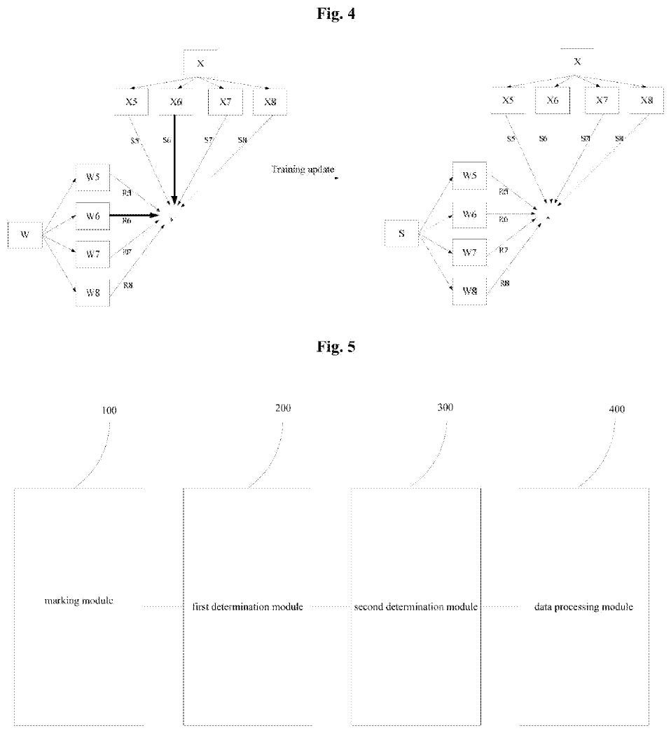

In a specific embodiment, the executing process of the above technical solution may be implemented based on the content shown in FIG. 4, referring to FIG. 4, FIG. 4 is a schematic diagram of determining an optimal quantization bit width provided by an embodiment of the present disclosure.

The determination of the optimal quantization bit width needs to perform performance evaluation when each quantization bit width is configured for the network model. FIG. 4 takes the convolution calculation of a certain layer in the network model as an example, as shown in FIG. 4, when the current layer is the key layer, the quantization bit width range thereof is [5 bit, 6 bit, 7 bit, 8 bit], at this moment, the weight W and the feature input X are respectively set to different quantization bit widths according to the quantization bit width range, which are respectively W5, W6, W7, W8 and X5, X6, X7, X8, then the weight and feature inputs are respectively mapped to different values according to the different quantization bit widths, convolution calculation is performed respectively, and importance evaluation is performed on each branch according to the convolution calculation result.

In FIG. 4, R represents a importance evaluation parameter of a weight branch, such as R5, R6, R7, R8; and S represents a importance evaluation parameter of a feature branch, such as S5, S6, S7, S8. In the whole process of determining the optimal quantization bit width, the importance coefficients R and S of each branch may be updated continuously according to the results of the training process, and the branch with the largest importance coefficient is the optimal number of quantization bit widths of the layer.

As shown in FIG. 4, after training for N times, the optimal quantization bit width of the weight branch of the convolution layer is 6 bit, and the optimal quantization bit width of the feature input branch is 8 bit.

In an embodiment, in the whole process of determining the optimal quantization bit width, in order to deploy the obtained model structure in the hardware environment better, in addition to the model accuracy as a training index, the hardware resource index (such as delay and throughput) may also be used as a constraint condition in the process of determining the optimal quantization bit width, and the training results may be evaluated. The process of determining the optimal quantization bit width is a process of learning the importance coefficient of each branch, so as to finally find the optimal quantization bit width.

Referring to FIG. 5, FIG. 5 is a structural diagram of a data processing system provided by an embodiment of the present disclosure.

The system may include:
a marking module 100, configured to mark each layer of a network model as a key layer or a non-key layer according to acquired structural information of the network model;
a first determination module 200, configured to respectively determine a quantization bit width range of the key layer and a quantization bit width range of the non-key layer according to hardware resource information that needs to be deployed;
a second determination module 300, configured to determine, in the quantization bit width range, optimal quantization bit widths of each layer of the network model;
a data processing module 400, configured to train the network model based on the optimal quantization bit widths of each layer of the network model, so as to obtain an optimal network model, and perform data processing using the optimal network model.

Based on the above embodiment, in a specific embodiment, the marking module 100 may include:
a sorting sub-module, configured to determine an initial network model parameter according to the acquired structural information of the network model, and sorting each layer of the network model;
a first marking sub-module, configured to mark a first layer of the network model as the key layer, and calculate a similarity between feature map of a current layer and feature map of a previous layer of the current layer in the network model according to the initial network model parameter;
a second marking sub-module, configured to mark the current layer as the key layer under the condition that the similarity is less than a threshold value;
a third marking sub-module, configured to mark the current layer as the non-key layer under the condition that the similarity is greater than or equal to the threshold value.

Based on the above embodiments, in a specific embodiment, the second determination module 300 may include:
a first determination sub-module, configured to determine the number of training branches of a current layer of the network model according to the number of quantization bit widths in the quantization bit width range;
a setting sub-module, configured to set different first quantization bit widths for weights in different training branches of the current layer of the network model, and set different second quantization bit widths for feature inputs in different training branches of the current layer of the network model;
a mapping sub-module, configured to map the weight to a weight value according to the first quantization bit width, and map the feature input to a feature input value according to the second quantization bit width;
a update sub-module, configured to perform convolution calculation on the weight value and the feature input value of each of the training branches, and update an importance evaluation parameter of the training branch according to an obtained convolution operation result; and
a second determination sub-module, configured to determine the first quantization bit width and the second quantization bit width of the training branch with highest importance evaluation parameter as the optimal quantization bit widths of the current layer of the network model.

Since the embodiment of the system part and the embodiments of the method part correspond to each other, the embodiments of the system part and the description of the embodiments of the method part may be referred to each other, which will not be elaborated herein.

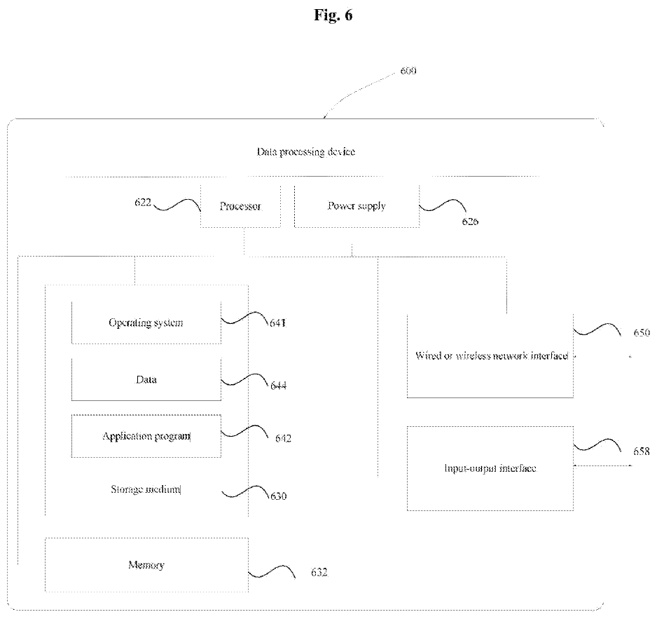

Referring to FIG. 6, FIG. 6 is a structural diagram of a data processing device provided by an embodiment of the present disclosure.

The data processing device 600 may vary widely depending on configuration or performance, and may include one or more processors (Central Processing Units, CPUs) 622 (such as one or more processors) and a memory 632, and one or more storage media 630 (such as one or more mass storage devices) that store applications 642 or data 644. Herein, the memory 632 and the storage medium 630 may be transient storage or persistent storage. A program stored in the storage medium 630 may include one or more modules (not shown), each of which may include a series of instruction operations on an apparatus. Further, the processor 622 may be configured to communicate with the storage medium 630 to execute a series of instruction operations in the storage medium 630 on the data processing device 600.

The data processing device 600 may also include one or more power supplies 626, one or more wired or wireless network interfaces 650, one or more input-output interfaces 658, and/or one or more operating systems 641, such as Windows Server™, mac OS X™, Unix™, Linux™, freeBSD™, etc.

The steps in the data processing method described in FIGS. 1 to 4 may be implemented by the data processing device based on the structure shown in FIG. 6.

Those skilled in the art may clearly learn about that specific working processes of the system, apparatus and modules described above may refer to the corresponding processes in the method embodiment and will not be elaborated herein for convenient and brief description.

In some embodiments provided by the present disclosure, it should be understood that the disclosed apparatus, device and method may be implemented in another manner. For example, the apparatus embodiment described above is only schematic, and for example, division of the modules is only logic function division, and other division manners may be adopted during practical implementation. For example, modules or components may be combined or integrated into another system, or some characteristics may be neglected or not executed. In addition, coupling or direct coupling or communication connection between each displayed or discussed component may be indirect coupling or communication connection, implemented through some interfaces, of the apparatus or the modules, and may be electrical and mechanical or adopt other forms.

The modules described as separate parts may or may not be physically separated, and parts displayed as modules may or may not be physical modules, and namely may be located in the same place, or may also be distributed to a plurality of network units. Part of all of the modules may be selected according to a practical requirement to achieve the purposes of the solutions of the embodiments.

In addition, each functional unit in each embodiment of the present disclosure may be integrated into a processing unit, each unit may also serve as an independent module and two or more than two modules may also be integrated into a module. The integrated module may be implemented in a hardware form and may also be implemented in form of hardware and software functional unit.

When being implemented in form of software functional module and sold or used as an independent product, the integrated module may be stored in a computer readable storage medium. Based on such an understanding, the technical solutions of the present disclosure essentially, or the part contributing to the related art, or all or part of the technical solutions may be implemented in a form of a software product. The computer software product is stored in a storage medium and includes a plurality of instructions for instructing a computer device (which may be a personal computer, a function call apparatus, or a network device) to perform all or some of the steps of the methods described in the embodiments of the present disclosure. The above-mentioned storage medium includes: various media capable of storing program codes such as a U disk, a mobile hard disk, a Read-Only Memory (ROM), a Random Access Memory (RAM), a magnetic disk, or an optical disk.

The data processing method, system and device, and the readable storage medium provided by the present disclosure are described above in detail. The principles and implementation modes of the present disclosure are described herein using specific examples, the foregoing description of the embodiments are only used to help the understanding of the method and core concept of the present disclosure. It is to be noted that a number of improvements and modifications may be made to the present disclosure by those of ordinary skill in the art without departing from the principle of the present disclosure, and all fall within the scope of protection of the claims of the present disclosure.

It is to be noted that relational terms “first”, “second” and the like in the present specification are adopted only to distinguish one entity or operation from another entity or operation and not always to require or imply existence of any such practical relationship or sequence between the entities or operations. Terms “include” and “have” or any other variation thereof is intended to cover nonexclusive inclusions, so that a process, method, object or device including a series of elements not only includes those elements, but also includes other elements that are not clearly listed, or further includes elements intrinsic to the process, the method, the object or the device Under the condition of no more limitations, an element defined by statement “including a/an . . . ” does not exclude existence of another element that is the same in a process, method, object or device including the element.

1. A data processing method, comprising:
marking each layer of a network model as a key layer or a non-key layer according to acquired structural information of the network model;
respectively determining a quantization bit width range of the key layer and a quantization bit width range of the non-key layer according to hardware resource information that needs to be deployed;
determining, in the quantization bit width range, optimal quantization bit widths of each layer of the network model; and
training the network model based on the optimal quantization bit widths of each layer of the network model, so as to obtain an optimal network model, and performing data processing using the optimal network model.

2. The method according to claim 1, wherein the marking each layer of a network model as a key layer or a non-key layer according to acquired structural information of the network model comprises:
determining an initial network model parameter according to the acquired structural information of the network model, and sorting each layer of the network model;
marking a first layer of the network model as the key layer, and calculating a similarity between feature map of a current layer and feature map of a previous layer of the current layer in the network model according to the initial network model parameter;
marking the current layer as the key layer under the condition that the similarity is less than a threshold value; and
marking the current layer as the non-key layer under the condition that the similarity is greater than or equal to the threshold value.

3. The method according to claim 1, wherein the determining, in the quantization bit width range, optimal quantization bit widths of each layer of the network model comprises:
determining the number of training branches of a current layer of the network model according to the number of quantization bit widths in the quantization bit width range;
setting different first quantization bit widths for weights in different training branches of the current layer of the network model, and setting different second quantization bit widths for feature inputs in different training branches of the current layer of the network model;
mapping the weight to a weight value according to the first quantization bit width, and mapping the feature input to a feature input value according to the second quantization bit width;
performing convolution calculation on the weight value and the feature input value of each of the training branches, and updating an importance evaluation parameter of the training branch according to an obtained convolution operation result; and
determining the first quantization bit width and the second quantization bit width of the training branch with highest importance evaluation parameter as the optimal quantization bit widths of the current layer of the network model.

4. The method according to claim 1, wherein any quantization bit wide the quantization bit wide range of the key layer is greater than any quantization bit wide in the quantization bit wide range of the non-key layer.

5. The method according to claim 1, wherein the network model comprises at least one of an image classification model, an image detection model, an image recognition model, and a natural language processing model.

6. (canceled)

7. (canceled)

8. (canceled)

9. A data processing device, comprising:
at least one processor; and
a memory, configured to store a computer program which can be run on the at least one processor, and the computer program, when being executed by the at least one processor, causes the at least one processor to:
marking each layer of a network model as a key layer or a non-key layer according to acquired structural information of the network model;
respectively determining a quantization bit width range of the key layer and a quantization bit width range of the non-key layer according to hardware resource information that needs to be deployed;
determining, in the quantization bit width range, optimal quantization bit widths of each layer of the network model; and
training the network model based on the optimal quantization bit widths of each layer of the network model, so as to obtain an optimal network model, and performing data processing using the optimal network model.

10. A non-transitory computer-readable storage medium, wherein a computer program is stored on the computer-readable storage medium, and when the computer program is executed by at least one processor, following operations are implemented:
marking each layer of a network model as a key layer or a non-key layer according to acquired structural information of the network model;
respectively determining a quantization bit width range of the key layer and a quantization bit width range of the non-key layer according to hardware resource information that needs to be deployed;
determining, in the quantization bit width range, optimal quantization bit widths of each layer of the network model; and
training the network model based on the optimal quantization bit widths of each layer of the network model, so as to obtain an optimal network model, and performing data processing using the optimal network model.

11. The method according to claim 1, wherein the key layer is selected based on Principal Component Analysis, or based on Hessian matrix decomposition.

12. The method according to claim 1, wherein the network model is selected based on a service that needs to be performed.

13. The method according to claim 1, wherein the hardware resource information includes a maximum model size or maximum computing resources bearable by a deployed platform.

14. The method according to claim 1, wherein under the condition that a maximum quantization bit width bearable by hardware resources that need to be deployed is 8 bits, the quantization bit width range of the key layer is set to [5 bit, Gbit, 7 bit, 8 bit], and the quantization bit width range of the non-key layer is set to [1 bit, 2 bit, 3 bit, 4 bit].

15. The method according to claim 1, wherein the optimal quantization bit widths of each layer of the network model are determined by a global search method or by an exhaustive method.

16. The method according to claim 1, wherein after the performing data processing using the optimal network model, the method further comprises:
outputting a prompt message for completion of the data processing to remind the user to further process of processed data.

17. The method according to claim 1, wherein a hardware resource index is used as a constraint condition in the process of determining the optimal quantization bit width to evaluating training results.

18. The method according to claim 3, wherein the number of the training branches of the current layer of the network model is product of the number of the quantization bit widths of weight and the number of quantization bit widths of feature input.

19. The method according to claim 3, wherein the importance evaluation parameter comprises a importance evaluation parameter of a weight branch and a importance evaluation parameter of a feature branch.

20. The device according to claim 9, wherein the processor, when executing the computer program, is further configured to:
determining an initial network model parameter according to the acquired structural information of the network model, and sorting each layer of the network model;
marking a first layer of the network model as the key layer, and calculating a similarity between feature map of a current layer and feature map of a previous layer of the current layer in the network model according to the initial network model parameter;
marking the current layer as the key layer under the condition that the similarity is less than a threshold value; and
marking the current layer as the non-key layer under the condition that the similarity is greater than or equal to the threshold value.

21. The device according to claim 9, wherein the processor, when executing the computer program, is further configured to:
determining the number of training branches of a current layer of the network model according to the number of quantization bit widths in the quantization bit width range;
setting different first quantization bit widths for weights in different training branches of the current layer of the network model, and setting different second quantization bit widths for feature inputs in different training branches of the current layer of the network model;
mapping the weight to a weight value according to the first quantization bit width, and mapping the feature input to a feature input value according to the second quantization bit width;
performing convolution calculation on the weight value and the feature input value of each of the training branches, and updating an importance evaluation parameter of the training branch according to an obtained convolution operation result; and
determining the first quantization bit width and the second quantization bit width of the training branch with highest importance evaluation parameter as the optimal quantization bit widths of the current layer of the network model.

22. The device according to claim 9, wherein any quantization bit wide the quantization bit wide range of the key layer is greater than any quantization bit wide in the quantization bit wide range of the non-key layer.

23. The device according to claim 9, wherein the network model comprises at least one of an image classification model, an image detection model, an image recognition model, and a natural language processing model.
